(19) United States
(12) Patent Application Publication
(10) Pub. No.: US 2026/0031562 A1
(43) Pub. Date: Jan. 29, 2026

(54) CONNECTOR

(71) Applicant: Tyco Electronics (Shanghai) Co., Ltd., Shanghai (CN)

(72) Inventors: Tommy Qian, Shanghai (CN); Xiao (Nichee) Zhou, Shanghai (CN); Xinquan (Jone) Ji, Shanghai (CN)

(73) Assignee: Tyco Electronics (Shanghai) Co., Ltd., Shanghai (CN)

(21) Appl. No.: 19/278,864

(22) Filed: Jul. 24, 2025

(30) Foreign Application Priority Data
Jul. 24, 2024 (CN) 202411002262.1

(51) Int. Cl. H01R 13/428; H01R 4/2429; H01R 13/11

(52) U.S. Cl. CPC H01R 13/428; H01R 13/112; H01R 4/2429

(57) ABSTRACT

A connector includes an insulation housing having a plurality of insertion slots extending in a longitudinal direction of the insulation housing and a plurality of terminals respectively inserted into the plurality of insertion slots. The plurality of terminals are arranged in a row in a transverse direction of the insulation housing. Each of the terminals has a crimping portion exposed from the insertion slot for crimping onto a cable. The crimping portions of the plurality of terminals are arranged in a front row and a rear row. The front row of crimping portions and the rear row of crimping portions are spaced apart by a first predetermined distance in the longitudinal direction of the insulation housing. The crimping portions of two adjacent terminals are spaced apart by the first predetermined distance in the longitudinal direction of the insulation housing.

### CROSS-REFERENCE TO RELATED APPLICATION

This application claims the benefit of the filing date under 35 U.S.C. § 119(a)-(d) of Chinese Patent Application No. 202411002262.1, filed on Jul. 24, 2024.

### FIELD OF THE INVENTION

The present invention relates to a connector.

### BACKGROUND OF THE INVENTION

A connector typically includes a housing and a plurality of terminals. The plurality of terminals are inserted into the housing and arranged in a row in a transverse direction of the housing. The terminal has a crimping portion exposed out of the housing, and the crimping portion is configured to be crimped onto a cable.

The crimping portions of the plurality of terminals are typically arranged in a row in the transverse direction of the housing, so that a spacing between the crimping portions of two adjacent terminals is equal to a pitch between the two adjacent terminals. In order to ensure that there is a sufficient creepage distance between the crimping portions of two adjacent terminals, the pitch between the two adjacent terminals should be not less than a predetermined creepage distance, which results in an excessively large pitch between two adjacent terminals and thus causes an excessively large volume of the connector.

### SUMMARY OF THE INVENTION

A connector includes an insulation housing having a plurality of insertion slots extending in a longitudinal direction of the insulation housing and a plurality of terminals respectively inserted into the plurality of insertion slots. The plurality of terminals are arranged in a row in a transverse direction of the insulation housing. Each of the terminals has a crimping portion exposed from the insertion slot for crimping onto a cable. The crimping portions of the plurality of terminals are arranged in a front row and a rear row. The front row of crimping portions and the rear row of crimping portions are spaced apart by a first predetermined distance in the longitudinal direction of the insulation housing. The crimping portions of two adjacent terminals are spaced apart by the first predetermined distance in the longitudinal direction of the insulation housing.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a connector according to an exemplary embodiment of the present invention;

FIG. 2 shows an illustrative exploded view of the connector according to an exemplary embodiment of the present invention;

FIG. 3 shows an illustrative plan view of the connector according to an exemplary embodiment of the present invention;

FIG. 4 shows an illustrative perspective view of two adjacent terminals in the connector according to an exemplary embodiment of the present invention;

FIG. 5 shows an illustrative perspective view of the connector according to an exemplary embodiment of the present invention, showing a cable;

FIG. 6 shows an illustrative perspective view of two adjacent terminals in a connector according to another exemplary embodiment of the present invention;

FIG. 7 shows an illustrative perspective view of two adjacent terminals in a connector according to another exemplary embodiment of the present invention;

FIG. 8 shows an illustrative perspective view of two adjacent terminals in a connector according to another exemplary embodiment of the present invention;

FIG. 9 shows an illustrative perspective view of two adjacent terminals in a connector according to another exemplary embodiment of the present invention;

FIG. 10 shows an illustrative perspective view of a connector according to another exemplary embodiment of the present invention;

FIG. 11 shows an illustrative exploded view of the connector according to another exemplary embodiment of the present invention;

FIG. 12 shows an illustrative plan view of the connector according to another exemplary embodiment of the present invention;

FIG. 13 shows an illustrative perspective view of a connector according to another exemplary embodiment of the present invention, in which no insulation housing is shown;

FIG. 14 shows an illustrative perspective view of a row of terminals of the connector according to another exemplary embodiment of the present invention; and

FIG. 15 shows an illustrative plan view of a row of terminals of the connector according to another exemplary embodiment of the present invention.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

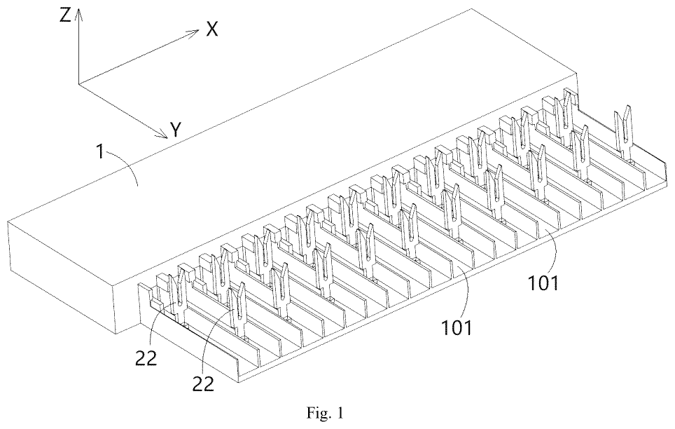

As shown in FIGS. 1 to 5, in an exemplary embodiment of the present invention, a connector is disclosed. The connector includes an insulation housing 1 and a plurality of terminals 2. The insulation housing 1 is formed with a plurality of insertion slots 101 which extend in a longitudinal direction Y of the insulation housing, and the plurality of insertion slots 101 are arranged in a row in a transverse direction X of the insulating housing 1. The plurality of terminals 2 are respectively inserted into the plurality of insertion slots 101. The plurality of terminals 2 are arranged in a row in the transverse direction X of the insulation housing 1, and each of the terminals 2 includes a crimping portion 22 which is exposed from the insertion slot 101 for crimping onto a cable 3. The crimping portions 22 of the plurality of terminals 2 are arranged in a front row and a rear row, the front row of crimping portions 22 and the rear row of crimping portions 22 are spaced apart by a first predetermined distance D1 in the longitudinal direction Y of the insulation housing 1, and the crimping portions 22 of two adjacent terminals 2 are spaced apart by the first predetermined distance D1 in the longitudinal direction Y of the insulation housing 1.

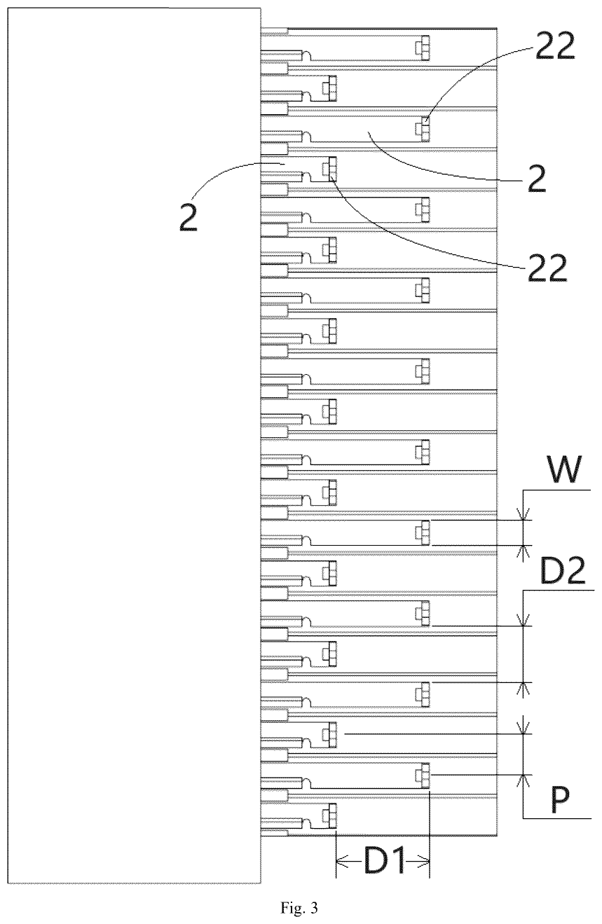

As shown in FIG. 3, in the illustrated embodiment, a spacing between two adjacent crimping portions 22 of the front row of crimping portions 22 and a spacing between two adjacent crimping portions 22 of the rear row of crimping portions 22 each is equal to a second predetermined distance D2. The second predetermined distance D2 is not less than a minimum creepage distance allowed by the connector, and the first predetermined distance D1 is not less than the second predetermined distance D2.

In the illustrated embodiment, the second predetermined distance D2 is equal to a difference between twice a pitch P between two adjacent terminals 2 and a width W of the crimping portion 22 in the transverse direction X of the insulation housing 1. In the illustrated embodiment, the second predetermined distance D2 is equal to the minimum creepage distance allowed by the connector, such that the pitch P between two adjacent terminals 2 is equal to half the sum of the minimum creepage distance allowed by the connector and the width W of the crimping portion 22 in the transverse direction X of the insulation housing 1.

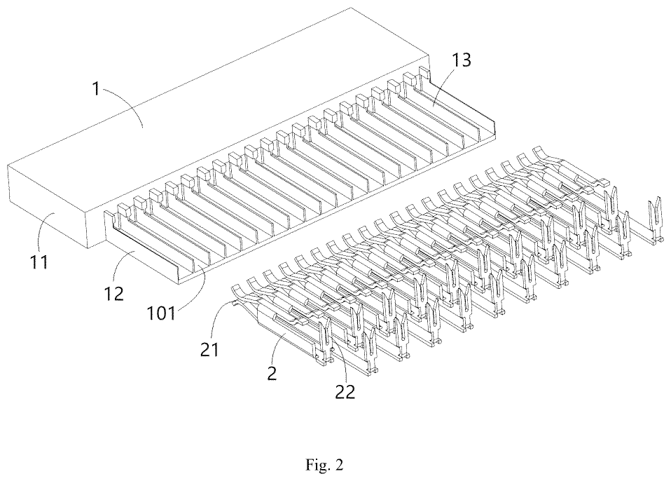

As shown in FIG. 2, in the illustrated embodiment, the insulation housing 1 includes a front portion 11 and a rear portion 12 opposite each other in the longitudinal direction Y of the insulation housing 1, a top opening is formed in the rear portion 12 of the insulation housing 1, and the crimping portions 22 of the plurality of terminals 2 extend upward in a height direction Z of the insulation housing 1 and extend out from the top opening of the rear portion 12 of the insulation housing 1.

As shown in FIG. 2, in the illustrated embodiment, a vertical partition wall 13 for separating two adjacent terminals 2 is formed at the rear portion 12 of the insulation housing 1, and a height dimension of the vertical partition wall 13 in the height direction Z of the insulation housing 1 is not less than the minimum creepage distance allowed by the connector.

In the illustrated embodiment, portions of the terminal 2 other than the crimping portion 22 are accommodated in the corresponding insertion slot 101 of the insulation housing 1.

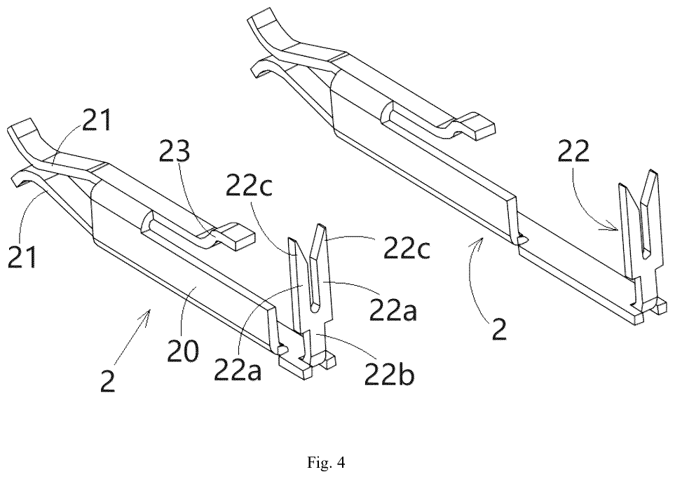

As shown in FIG. 4, in the illustrated embodiment, the terminal 2 further includes a main body portion 20 and an elastic arm 21. The main body portion 20 is fixed in the corresponding insertion slot 101 of the insulation housing 1. The elastic arm 21 is connected to a front end of the main body portion 20 and suspended in the insertion slot 101. The crimping portion 22 is connected to a rear end of the main body portion 20, and the elastic arm 21 is configured to make electrical contact with a mating terminal of a mating connector inserted into the insertion slot 101.

In the illustrated embodiment, the main body portion 20 of the terminal 2 is inserted into the insertion slot 101 of the insulation housing 1 in an interference fit manner, such that the main body portion 20 of the terminal 2 is fixed in the insertion slot 101 of the insulation housing 1.

As shown in FIG. 4, in the illustrated embodiment, a locking spring tab 23 is formed on the main body portion 20 of the terminal 2, and the locking spring tab 23 is engaged with an inner wall of the insulation housing 1 to lock the terminal 2 in the insertion slot 101 of the insulation housing 1.

In the illustrated embodiment, the terminal 2 is an integral stamped part, and the housing 1 is an integral overmolded part.

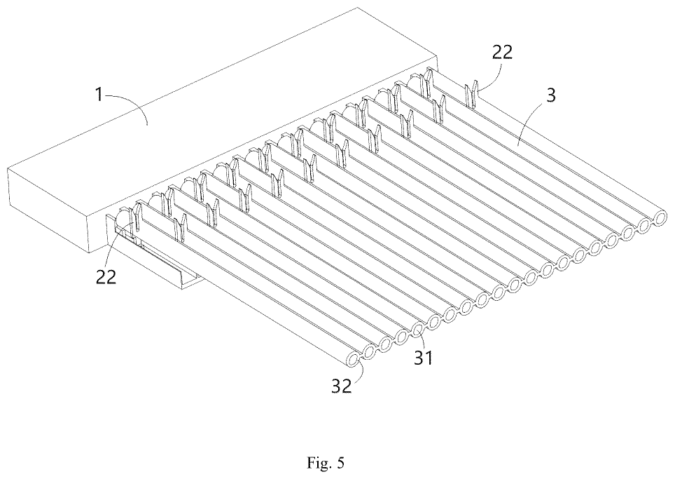

As shown in FIG. 5, in the illustrated embodiment, the connector further includes a cable 3 which is flat and includes a row of conductor cores 31 and an insulation layer 32 wrapping the row of conductor cores 31. The crimping portions 22 of a row of terminals 2 are respectively crimped onto the row of conductor cores 31 of the cable 3 to be respectively electrically connected to the row of conductor cores 31. In the illustrated embodiment, the crimping portions 22 of the terminals 2 extend out of the insulation housing 1 in the height direction Z of the insulation housing 1, and the conductor cores 31 of the cable 3 extend in the longitudinal direction Y of the insulation housing 1.

As shown in FIG. 4, in the illustrated embodiment, the crimping portion 22 is fork-shaped and includes a pair of clamping plates 22a and a connecting plate 22b. The pair of clamping plates 22a are spaced apart from and arranged opposite each other in the transverse direction X of the insulation housing 1. The connecting plate 22b is connected between bottom portions of the pair of clamping plates 22a and the main body portion 20 of the terminal 2. The pair of clamping plates 22a are configured to clamp the conductor core 31 of the cable 3 for electrical connection with the conductor core 31 of the cable 3.

As shown in FIG. 4, in the illustrated embodiment, a sharp-tipped piercing portion 22c is formed on a top portion of each of the pair of clamping plates 22a, and the sharp-tipped piercing portions 22c are configured to pierce the insulation layer 32 of the cable 3 and are crimped onto the insulation layer 32 of the cable 3.

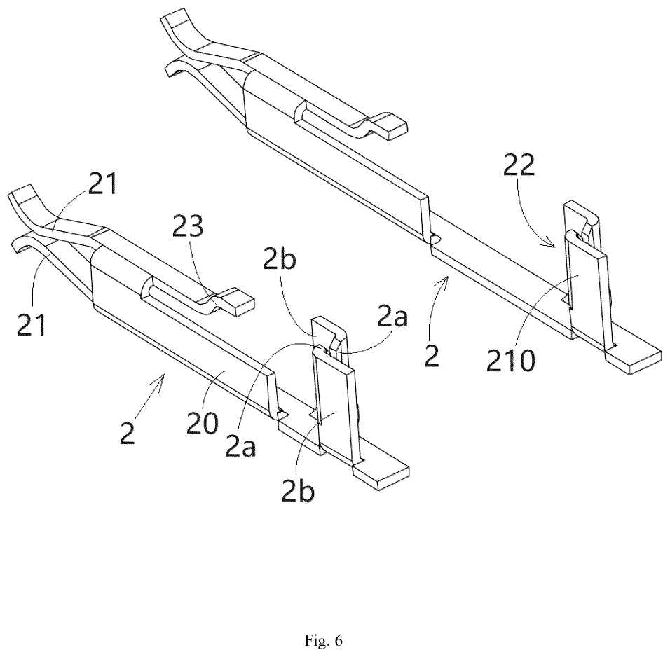

FIG. 6 shows an illustrative perspective view of two adjacent terminals 2 in a connector according to another exemplary embodiment of the present invention. The embodiment shown in FIG. 6 differs from the embodiment shown in FIGS. 1-5 only in the structure of the crimping portion 22.

As shown in FIG. 6, in the illustrated embodiment, the crimping portion 22 includes a pair of L-shaped clamping portions 210, and each of the L-shaped clamping portions 210 includes a clamping plate 2a and a connecting plate 2b perpendicularly connected to a side portion of the clamping plate 2a. The clamping plates 2a of the pair of L-shaped clamping portions 210 are spaced apart from and arranged opposite each other in the transverse direction X of the insulation housing 1, and are configured to clamp the conductor core 31 of the cable 3 for electrical connection with the conductor core 31 of the cable 3. Lower ends of the connecting plates 2b of the pair of L-shaped clamping portions 210 are respectively connected to two sides of the main body portion 20 of the terminal 2.

Apart from the aforementioned difference, the embodiment shown in FIG. 6 is substantially identical to the embodiment shown in FIGS. 1-5 in other technical features, and reference may be made to the embodiment shown in FIGS. 1-5 for these features.

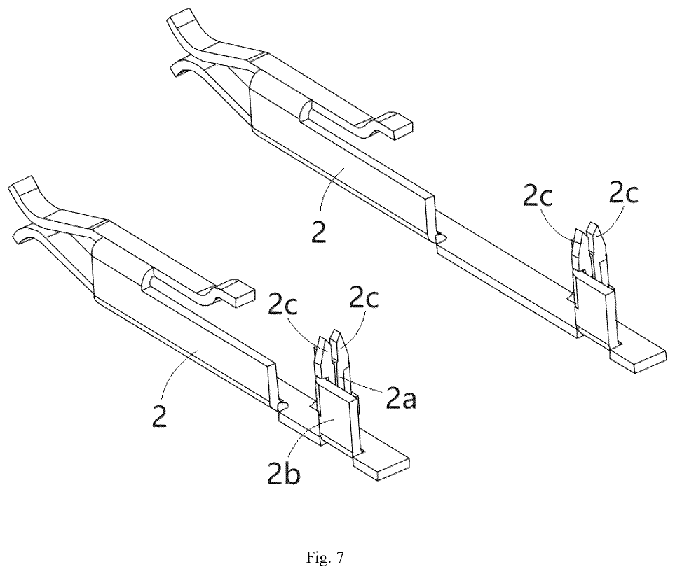

FIG. 7 shows an illustrative perspective view of two adjacent terminals 2 in a connector according to another exemplary embodiment of the present invention. The embodiment shown in FIG. 7 differs from the embodiments shown in FIGS. 1-6 only in the structure of the crimping portion 22.

As shown in FIG. 7, in the illustrated embodiment, the crimping portion 22 includes a pair of L-shaped clamping portions 210, and each of the L-shaped clamping portions 210 includes a clamping plate 2a and a connecting plate 2b perpendicularly connected to a side portion of the clamping plate 2a. The clamping plates 2a of the pair of L-shaped clamping portions 210 are spaced apart from and arranged opposite each other in the transverse direction X of the insulation housing 1, and are configured to clamp the conductor core 31 of the cable 3 for electrical connection with the conductor core 31 of the cable 3. Lower ends of the connecting plates 2b of the pair of L-shaped clamping portions 210 are respectively connected to two sides of the main body portion 20 of the terminal 2.

As shown in FIG. 7, in the illustrated embodiment, a sharp-tipped piercing portion 2c is formed on a top portion of each of the clamping plates 2a of the pair of L-shaped clamping portions 210, and the sharp-tipped piercing portions 2c are configured to pierce the insulation layer 32 of the cable 3 and are crimped onto the insulation layer 32 of the cable 3.

Apart from the aforementioned difference, the embodiment shown in FIG. 7 is substantially identical to the embodiment shown in FIGS. 1-6 in other technical features, and reference may be made to the embodiment shown in FIGS. 1-6 for these features.

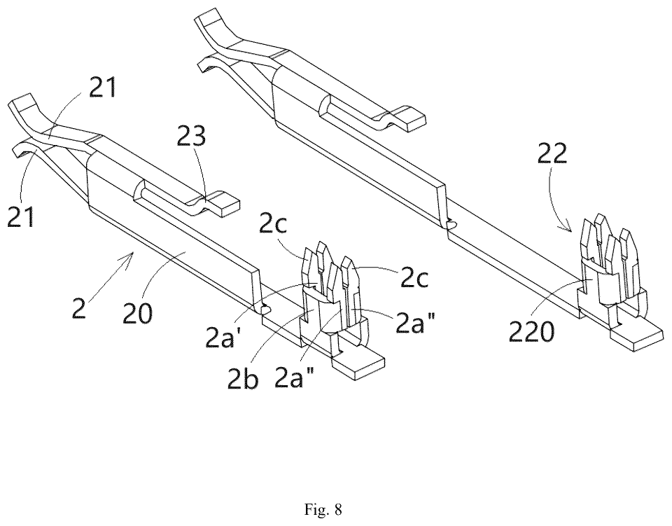

FIG. 8 shows an illustrative perspective view of two adjacent terminals 2 in a connector according to another exemplary embodiment of the present invention. The embodiment shown in FIG. 8 differs from the embodiments shown in FIGS. 1-7 only in the structure of the crimping portion 22.

As shown in FIG. 8, in the illustrated embodiment, the crimping portion 22 includes a pair of U-shaped clamping portions 220, and each of the pair of U-shaped clamping portions 220 includes a front clamping plate 2a′ and a rear clamping plate 2a″ spaced apart in the longitudinal direction Y of the insulation housing 1 and a connecting plate 2b connected between the front clamping plate 2a′ and the rear clamping plate 2a″. The front clamping plates 2a′ of the pair of U-shaped clamping portions 220 are spaced apart from and arranged opposite each other in the transverse direction X of the insulation housing 1 and are configured to clamp the conductor core 31 of the cable 3. The rear clamping plates 2a″ of the pair of U-shaped clamping portions 220 are spaced apart from and arranged opposite each other in the transverse direction X of the insulation housing 1 and are configured to clamp the conductor core 31 of the cable 3. Lower ends of the connecting plates 2b of the pair of U-shaped clamping portions 220 are respectively connected to two sides of the main body portion 20 of the terminal 2.

As shown in FIG. 8, in the illustrated embodiment, a sharp-tipped piercing portion 2c is formed on a top portion of each of the front clamping plate 2a′ and the rear clamping plate 2a″ of the pair of U-shaped clamping portions 220, and the sharp-tipped piercing portions 2c are configured to pierce the insulation layer 32 of the cable 3 and are crimped onto the insulation layer 32 of the cable 3.

Apart from the aforementioned difference, the embodiment shown in FIG. 8 is substantially identical to the embodiment shown in FIGS. 1-7 in other technical features, and reference may be made to the embodiment shown in FIGS. 1-7 for these features.

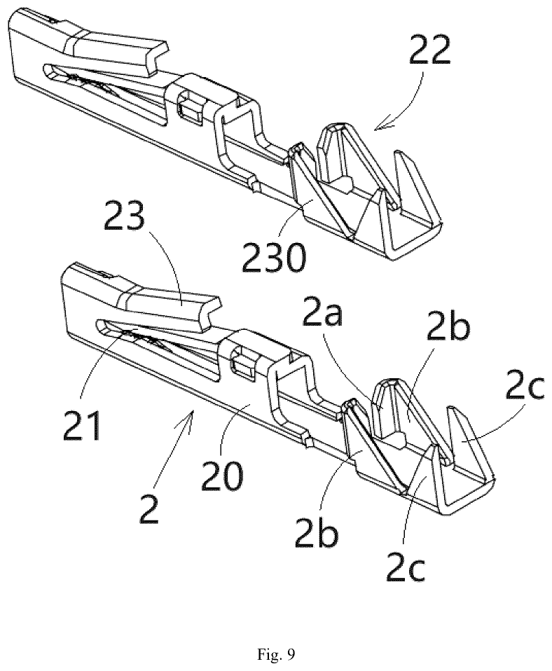

FIG. 9 shows an illustrative perspective view of two adjacent terminals 2 in a connector according to another exemplary embodiment of the present invention. The embodiment shown in FIG. 9 differs from the embodiments shown in FIGS. 1-8 only in the structure of the crimping portion 22.

As shown in FIG. 9, in the illustrated embodiment, the crimping portion 22 includes a pair of clamping portions 230 and a pair of sharp-tipped piercing portions 2c, the pair of clamping portions 230 and the pair of sharp-tipped piercing portions 2c are spaced apart in the longitudinal direction Y of the insulation housing 1. The pair of clamping portions 230 are configured to clamp a conductor core 31 of the cable 3 for electrical connection with the conductor core 31 of the cable 3, and the pair of sharp-tipped piercing portions 2c are configured to pierce the insulation layer 32 of the cable 3 and are crimped onto the insulation layer 32 of the cable 3.

As shown in FIG. 9, in the illustrated embodiment, the clamping portion 230 includes a clamping plate 2a and a connecting plate 2b perpendicularly connected to a side portion of the clamping plate 2a, and lower sides of the connecting plates 2b of the pair of clamping portions 230 are respectively connected to the two sides of the main body portion 20 of the terminal 2. Lower sides of the pair of sharp-tipped piercing portions 2c are respectively connected to the two sides of the main body portion 20 of the terminal 2, the connecting plate 2b and the sharp-tipped piercing portions 2c are in the shape of a triangular plate, and a V-groove is defined between the connecting plate 2b and the sharp-tipped piercing portion 2c on the same side of the terminal 1.

Apart from the aforementioned difference, the embodiment shown in FIG. 9 is substantially identical to the embodiment shown in FIGS. 1-8 in other technical features, and reference may be made to the embodiment shown in FIGS. 1-8 for these features.

As shown in FIGS. 1-8, in the illustrated embodiment, two adjacent terminals 2 of the plurality of terminals 2 have different lengths in the longitudinal direction Y of the insulation housing 1, front ends of the two adjacent terminals 2 are flush, and rear ends of the two adjacent terminals 2 are staggered by the first predetermined distance D1 in the longitudinal direction Y.

As shown in FIG. 9, in the illustrated embodiment, two adjacent terminals 2 of the plurality of terminals 2 have the same length in the longitudinal direction Y of the insulation housing 1, front ends of the two adjacent terminals 2 are staggered by the first predetermined distance D1 in the longitudinal direction Y, and rear ends of the two adjacent terminals 2 are staggered by the first predetermined distance D1 in the longitudinal direction Y. As shown in FIG. 9, in the illustrated embodiment, two adjacent terminals 2 of the plurality of terminals 2 are identical and thus can be used interchangeably.

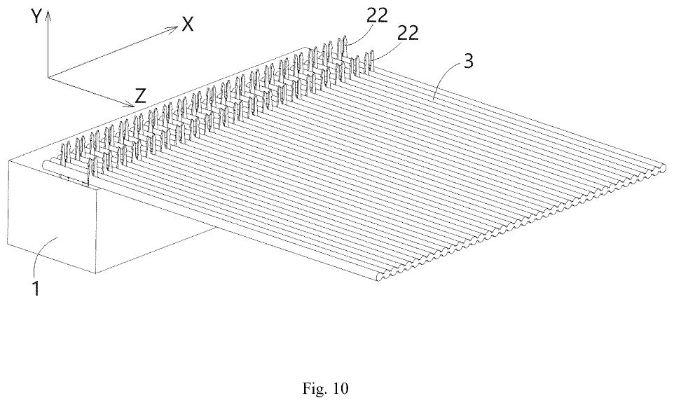

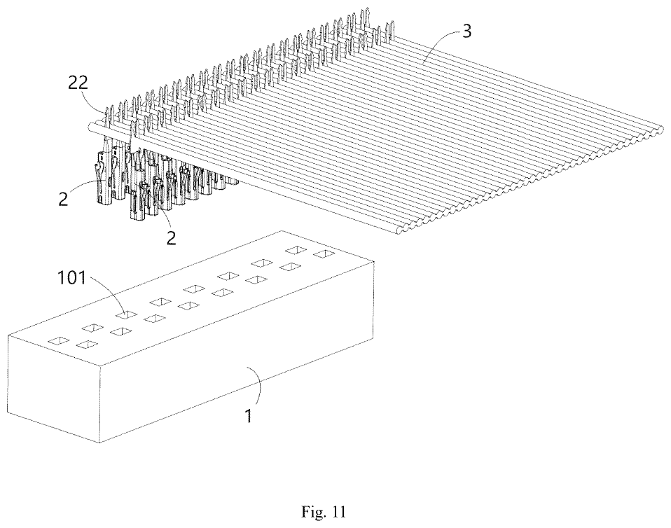

As shown in FIGS. 10-12, in an exemplary embodiment of the present invention, a connector is disclosed. The connector includes an insulation housing 1 and a plurality of terminals 2. The insulation housing 1 is formed with a plurality of insertion slots 101 which extend in a longitudinal direction Y of the insulation housing. The plurality of terminals 2 are respectively inserted into the plurality of insertion slots 101. The plurality of terminals 2 are arranged in an upper row and a lower row in a height direction Z of the insulation housing 1, and each of the terminals 2 includes a crimping portion 22 extending out from the insertion slot 101 for crimping onto a cable 3.

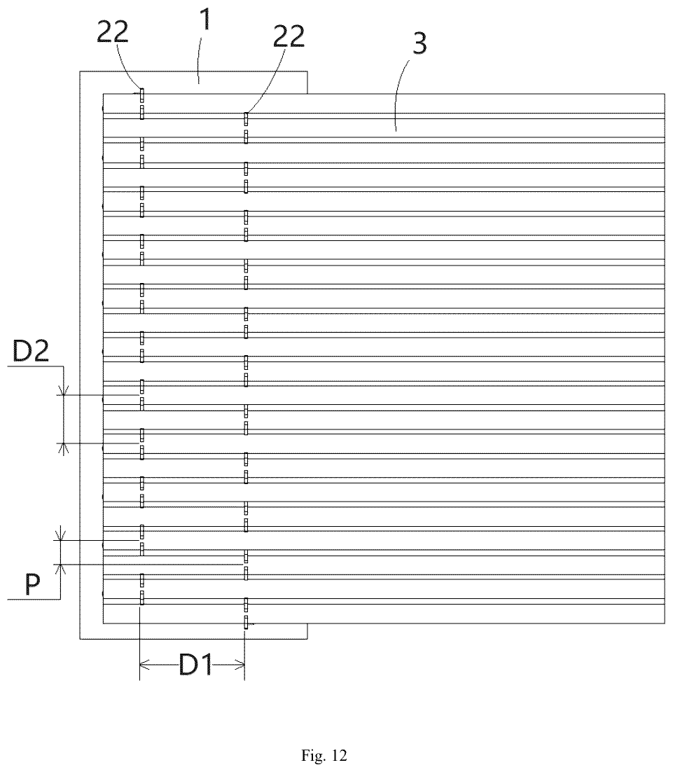

As shown in FIGS. 12, in the illustrated embodiment, the crimping portions 22 of the upper row of terminals 2 and the crimping portions 22 of the lower row of terminals 2 are spaced apart by a pitch P in a transverse direction X of the insulation housing 1, and the crimping portions 22 of the upper row terminals 2 and the crimping portions 22 of the lower row of terminals 2 are spaced apart by a first predetermined distance D1 in the height direction Z of the insulation housing 1.

As shown in FIGS. 12, in the illustrated embodiment, the crimping portions 22 of two adjacent terminals 2 of the same row of terminals 2 are spaced apart by a second predetermined distance D2 in the transverse direction X of the insulation housing 1, and the second predetermined distance D2 is equal to twice the pitch P. The first predetermined distance D1 is not less than the second predetermined distance D2, and the second predetermined distance D2 is not less than a minimum creepage distance allowed by the connector.

As shown in FIGS. 10-12, in the illustrated embodiment, the connector further includes a cable 3 which is flat and includes a row of conductor cores 31 (see FIG. 5) and an insulation layer 32 (see FIG. 5) wrapping the row of conductor cores 31. The crimping portions 22 of the plurality of terminals 2 are respectively crimped onto the row of conductor cores 31 of the cable 3 to respectively electrically connected to the row of conductor cores 31.

As shown in FIGS. 10-12, in the illustrated embodiment, the crimping portions 22 of the terminals 2 extend out of the insulation housing 1 in the longitudinal direction Y of the insulation housing 1, and the conductor cores 31 of the cable 3 extend in the height direction Z of the insulation housing 1.

As shown in FIGS. 10-12, in the illustrated embodiment, the plurality of terminals 2 are identical and thus any two of the terminals can be used interchangeably.

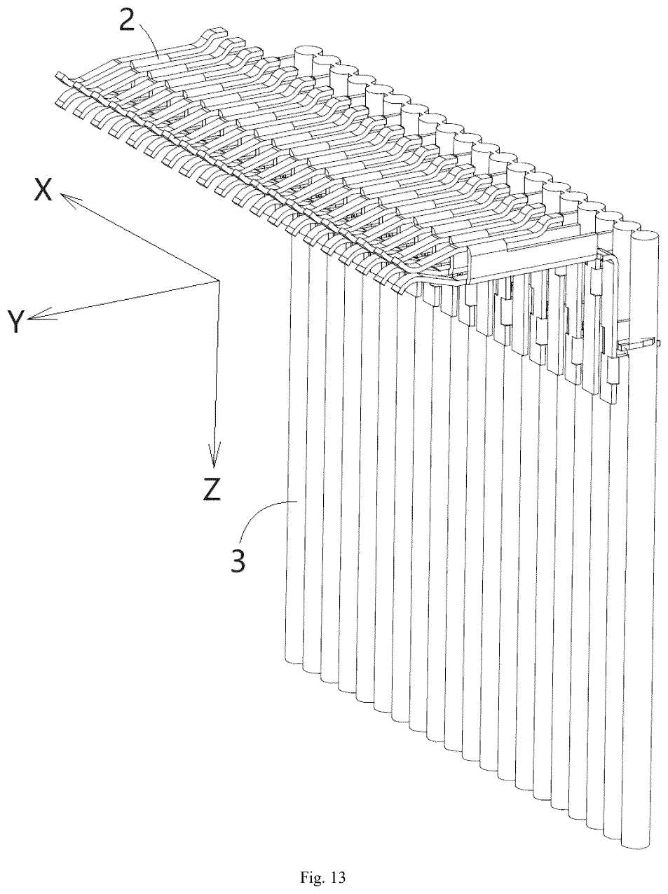

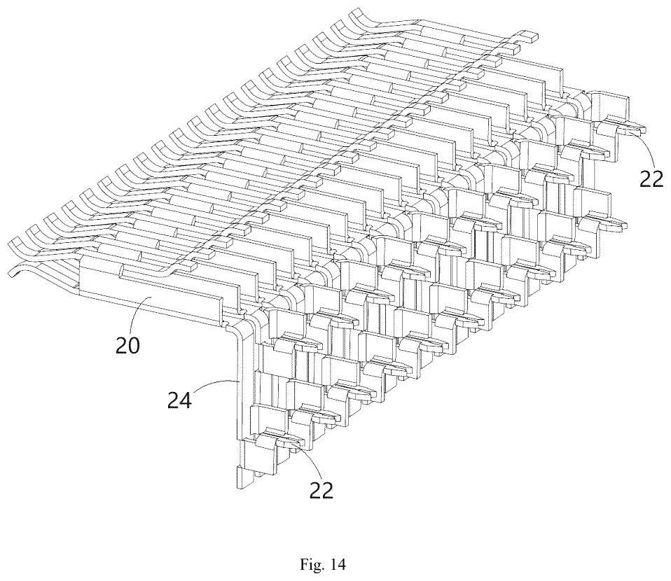

As shown in FIGS. 13-15, in an exemplary embodiment of the present invention, a connector is disclosed. The connector includes an insulation housing 1 (see FIGS. 1-5) and a plurality of terminals 2. The insulation housing 1 is formed with a plurality of insertion slots 101 which extend in a longitudinal direction Y of the insulation housing. The plurality of terminals 2 are arranged in a row in a transverse direction X of the insulation housing 1. The terminal 2 includes a main body portion 20, a bent portion 24 and a crimping portion 22. The main body portion 20 of the terminal 2 is inserted into the corresponding insertion slot 101 of the insulation housing 1. The bent portion 24 of the terminal 2 is connected to a rear end of the main body portion 20 and perpendicularly bent relative to the main body portion 20. The crimping portion 22 of the terminal 2 is perpendicularly connected to the bent portion 24 and exposed from the insulation housing 1 for crimping onto a cable 3.

As shown in FIGS. 13-15, in the illustrated embodiment, the crimping portions 22 of the plurality of terminals 2 are arranged in an upper row and a lower row in a height direction Z of the insulation housing 1, the upper row of crimping portions 22 and the low row of crimping portions 22 are spaced apart by a first predetermined distance D1 in the height direction Z of the insulation housing 1, and the crimping portions 22 of two adjacent terminals 2 are spaced apart by the first predetermined distance D1 in the height direction Z of the insulation housing 1.

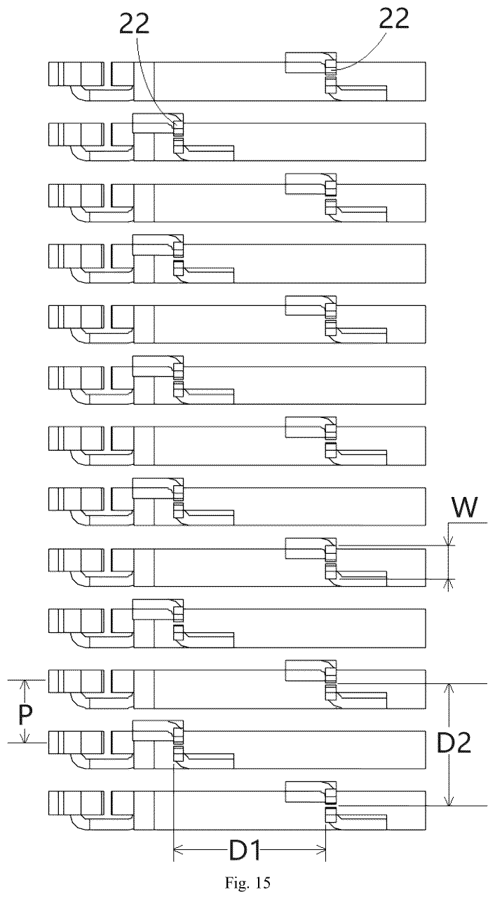

As shown in FIG. 15, in the illustrated embodiment, a spacing between two adjacent crimping portions 22 of the upper row of crimping portions 22 and a spacing between two adjacent crimping portions 22 of the lower row of crimping portions 22 each is equal to a second predetermined distance D2. The second predetermined distance D2 is not less than a minimum creepage distance allowed by the connector, and the first predetermined distance D1 is not less than the second predetermined distance D2.

In the illustrated embodiment, the second predetermined distance D2 is equal to a difference between twice a pitch P between two adjacent terminals 2 and a width W of the crimping portion 22 in the transverse direction X of the insulation housing 1. In the illustrated embodiment, the second predetermined distance D2 is equal to the minimum creepage distance allowed by the connector, such that the pitch P between two adjacent terminals 2 is equal to half the sum of the minimum creepage distance allowed by the connector and the width W of the crimping portion 22 in the transverse direction X of the insulation housing 1.

As shown in FIGS. 13-15, in the illustrated embodiment, the connector further includes a cable 3 which is flat and includes a row of conductor cores 31 and an insulation layer 32 wrapping the row of conductor cores 31 (see FIGS. 1-5). The crimping portions 22 of the plurality of terminals 2 are respectively crimped onto the row of conductor cores 31 of the cable 3 and are respectively electrically connected to the row of conductor cores 31.

As shown in FIGS. 13-15, in the illustrated embodiment, the bent portion 24 of the terminal 2 extends in the height direction Z of the insulation housing 1, the crimping portion 22 extends in the longitudinal direction Y of the insulation housing 1, and the conductor core 31 of the cable 3 extends in the height direction Z of the insulation housing 1.

The primary difference between the embodiments shown in FIGS. 13-15 and those shown in FIGS. 1-9 lies in the terminals 2 being bent at 90 degrees. Other technical features remain substantially identical to the embodiments shown in FIGS. 1-9, for which reference may be made to the afore-mentioned FIGS. 1-9. Consequently, the protection scope of the present invention covers configurations where the terminals 2 in the embodiments of FIGS. 1-9 are bent at 90 degrees.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector, comprising:
an insulation housing having a plurality of insertion slots extending in a longitudinal direction of the insulation housing; and
a plurality of terminals respectively inserted into the plurality of insertion slots, the plurality of terminals are arranged in a row in a transverse direction of the insulation housing, each of the terminals has a crimping portion exposed from the insertion slot for crimping onto a cable, the crimping portions of the plurality of terminals are arranged in a front row and a rear row, the front row of crimping portions and the rear row of crimping portions are spaced apart by a first predetermined distance in the longitudinal direction of the insulation housing, the crimping portions of two adjacent terminals are spaced apart by the first predetermined distance in the longitudinal direction of the insulation housing.

2. The connector according to claim 1, wherein a spacing between two adjacent crimping portions of the front row of crimping portions and a spacing between two adjacent crimping portions of the rear row of crimping portions each is equal to a second predetermined distance, the second predetermined distance is not less than a minimum creepage distance allowed by the connector, the first predetermined distance is not less than the second predetermined distance.

3. The connector according to claim 2, wherein the second predetermined distance is equal to a difference between twice a pitch between two adjacent terminals and a width of the crimping portion in the transverse direction of the insulation housing.

4. The connector according to claim 3, wherein the second predetermined distance is equal to the minimum creepage distance allowed by the connector, the pitch between two adjacent terminals is equal to half a sum of the minimum creepage distance allowed by the connector and the width of the crimping portion in the transverse direction of the insulation housing.

5. The connector according to claim 1, wherein the terminal further includes a main body portion fixed in one of the insertion slots of the insulation housing and an elastic arm connected to a front end of the main body portion and suspended in the insertion slot, the crimping portion is connected to a rear end of the main body portion, the elastic arm electrically contacts a mating terminal of a mating connector inserted into the insertion slot.

6. The connector according to claim 5, wherein the crimping portion is fork-shaped and includes:
a pair of clamping plates spaced apart from and arranged opposite each other in the transverse direction of the insulation housing; and
a connecting plate connected between a pair of bottom portions of the pair of clamping plates and the main body portion of the terminal, the pair of clamping plates clamp a conductor core of the cable for electrical connection with the conductor core of the cable.

7. The connector according to claim 6, wherein a sharp-tipped piercing portion is formed on a top portion of each of the pair of clamping plates, the sharp-tipped piercing portions pierce an insulation layer of the cable and are crimped onto the insulation layer of the cable.

8. The connector according to claim 5, wherein the crimping portion includes a pair of L-shaped clamping portions, each of the L-shaped clamping portions has a clamping plate and a connecting plate perpendicularly connected to a side portion of the clamping plate, the clamping plates of the pair of L-shaped clamping portions are spaced apart from and arranged opposite each other in the transverse direction of the insulation housing, and clamp a conductor core of the cable for electrical connection with the conductor core of the cable, a pair of lower ends of the connecting plates of the pair of L-shaped clamping portions are respectively connected to two sides of the main body portion of the terminal.

9. The connector according to claim 8, wherein a sharp-tipped piercing portion is formed on a top portion of each of the clamping plates of the pair of L-shaped clamping portions, the sharp-tipped piercing portions pierce an insulation layer of the cable and are crimped onto the insulation layer of the cable.

10. The connector according to claim 5, wherein the crimping portion includes a pair of U-shaped clamping portions, each of the pair of U-shaped clamping portions has a front clamping plate and a rear clamping plate spaced apart in the longitudinal direction of the insulation housing and a connecting plate connected between the front clamping plate and the rear clamping plate, the front clamping plates of the pair of U-shaped clamping portions are spaced apart from and arranged opposite each other in the transverse direction of the insulation housing and clamp a conductor core of the cable, the rear clamping plates of the pair of U-shaped clamping portions are spaced apart from and arranged opposite each other in the transverse direction of the insulation housing and clamp the conductor core of the cable, a pair of lower ends of the connecting plates of the pair of U-shaped clamping portions are respectively connected to two sides of the main body portion of the terminal.

11. The connector according to claim 10, wherein a sharp-tipped piercing portion is formed on a top portion of each of the front clamping plate and the rear clamping plate of the pair of U-shaped clamping portions, the sharp-tipped piercing portions pierce the insulation layer of the cable and are crimped onto the insulation layer of the cable.

12. The connector according to claim 5, wherein the crimping portion includes a pair of clamping portions and a pair of sharp-tipped piercing portions, the pair of clamping portions and the pair of sharp-tipped piercing portions are spaced apart in the longitudinal direction of the insulation housing, the pair of clamping portions clamp a conductor core of the cable for electrical connection with the conductor core of the cable, the pair of sharp-tipped piercing portions pierce an insulation layer of the cable and are crimped onto the insulation layer of the cable.

13. The connector according to claim 12, wherein the clamping portion includes a clamping plate and a connecting plate perpendicularly connected to a side portion of the clamping plate, a pair of lower sides of the connecting plates of the pair of clamping portions are respectively connected to the two sides of the main body portion of the terminal, a pair of lower sides of the pair of sharp-tipped piercing portions are respectively connected to the two sides of the main body portion of the terminal, the connecting plate and the sharp-tipped piercing portions are in the shape of a triangular plate, and a V-groove is defined between the connecting plate and the sharp-tipped piercing portion on a same side of the terminal.

14. The connector according to claim 1, wherein:
two adjacent terminals of the plurality of terminals have different lengths in the longitudinal direction of the insulation housing, front ends of the two adjacent terminals are flush, and rear ends of the two adjacent terminals are staggered by the first predetermined distance in the longitudinal direction; or
two adjacent terminals of the plurality of terminals have the same length in the longitudinal direction of the insulation housing, front ends of the two adjacent terminals are staggered by the first predetermined distance in the longitudinal direction, and rear ends of the two adjacent terminals are staggered by the first predetermined distance in the longitudinal direction.

15. A connector, comprising:
an insulation housing having plurality of insertion slots extending in a longitudinal direction of the insulation housing; and
a plurality of terminals respectively inserted into the plurality of insertion slots, the plurality of terminals are arranged in an upper row and a lower row in a height direction of the insulation housing, each of the terminals has a crimping portion extending out from the insertion slot for crimping onto a cable, the crimping portions of the upper row of terminals and the crimping portions of the lower row of terminals are spaced apart by a pitch in a transverse direction of the insulation housing, the crimping portions of the upper row terminals and the crimping portions of the lower row of terminals are spaced apart by a first predetermined distance in the height direction of the insulation housing.

16. The connector according to claim 15, wherein the crimping portions of two adjacent terminals of the same row of terminals are spaced apart by a second predetermined distance in the transverse direction of the insulation housing, the second predetermined distance being equal to twice the pitch, the first predetermined distance is not less than the second predetermined distance, and the second predetermined distance is not less than a minimum creepage distance allowed by the connector.

17. A connector, comprising:
an insulation housing having a plurality of insertion slots extending in a longitudinal direction of the insulation housing; and
a plurality of terminals arranged in a row in a transverse direction of the insulation housing, the terminals each include:
a main body portion inserted into one of the insertion slots of the insulation housing;
a bent portion connected to a rear end of the main body portion and perpendicularly bent relative to the main body portion; and
a crimping portion perpendicularly connected to the bent portion and exposed from the insulation housing for crimping onto a cable, the crimping portions of the plurality of terminals are arranged in an upper row and a lower row in a height direction of the insulation housing, the upper row of crimping portions and the low row of crimping portions are spaced apart by a first predetermined distance in the height direction of the insulation housing, and the crimping portions of two adjacent terminals are spaced apart by the first predetermined distance in the height direction of the insulation housing.

18. The connector according to claim 17, wherein a spacing between two adjacent crimping portions of the upper row of crimping portions and a spacing between two adjacent crimping portions of the lower row of crimping portions each is equal to a second predetermined distance, the second predetermined distance is not less than a minimum creepage distance allowed by the connector, the first predetermined distance is not less than the second predetermined distance.

19. The connector according to claim 18, wherein the second predetermined distance is equal to a difference between twice a pitch between two adjacent terminals and a width of the crimping portion in the transverse direction of the insulation housing.

20. The connector according to claim 19, wherein the second predetermined distance is equal to the minimum creepage distance allowed by the connector, the pitch between two adjacent terminals is equal to half a sum of the minimum creepage distance allowed by the connector and the width of the crimping portion in the transverse direction of the insulation housing.
